(19) United States
(12) Patent Application Publication
(10) Pub. No.: US 2012/0027176 A1
(43) Pub. Date: Feb. 2, 2012

(54) Method for X-Ray Imaging Using Scattered Radiation

(76) Inventor: Oliver Heid, Erlangen (DE)

(21) Appl. No.: 13/144,121

(22) PCT Filed: Nov. 6, 2009
(86) PCT No.: PCT/EP2009/064737

§ 371 Date: Jul. 12, 2011

(30) Foreign Application Priority Data
Jan. 12, 2009 (DE) 10 2009 004 334.9

(51) Int. Cl. G01N 23/201

(52) U.S. Cl. 378/87

(57) ABSTRACT

An object (8) is x-rayed using one or more x-ray pulses in successive timed intervals. On volume elements of the object (8), in a direction different from the x-ray direction, the scattered x-ray radiation is recorded in a time and spatially resolved manner by way of an x-ray detector (9) using a two-dimensional arrangement of detector elements. By way of the known geometry and propagation of the wave front of the x-ray pulses, an image data record of a three-dimensional scatter distribution of the object (8) is reconstructed from the spatially and time-resolved measurement data. The method enables the creation of an image data record of the three-dimensional scattered radiation distribution using only one x-ray pulse and can thus be carried out very easily.

### CROSS-REFERENCE TO RELATED APPLICATIONS

This application is a U.S. National Stage Application of International Application No. PCT/EP2009/064737 filed Nov. 6, 2009, which designates the United States of America, and claims priority to DE Application No. 10 2009 004 334.9 filed Jan. 12, 2009. The contents of which are hereby incorporated by reference in their entirety.

### TECHNICAL FIELD

The present invention relates to a method and a device for X-ray imaging, in which an object is X-rayed by an X-ray beam bundle emanating from an X-ray source.

### BACKGROUND

It is well known that X-ray beams are very difficult to focus, and so known X-ray imaging methods generally record projections. In the process, at least one spatial dimension is lost, which can only be recreated by multiple projections and subsequent reconstruction of a three-dimensional image data record from the projection data, as is the case in e.g. computed tomography. However, this requires a multiplicity of X-ray recordings from different directions and therefore is complicated and time-consuming.

### SUMMARY

According to various embodiments, an alternative method for X-ray imaging can be specified, which can be carried out with less effort and provides three-dimensional image information of the object.

According to an embodiment, in a method for X-ray imaging, in which an object is X-rayed by an X-ray beam bundle emanating from an X-ray source,—one or more successive X-ray pulses, spaced apart in time, are used for the X-raying,—X-ray radiation, scattered at volume elements of the object, is recorded in a direction deviating from an X-raying direction by an X-ray detector with a two-dimensional arrangement of detector elements with a temporal and spatial resolution, and -an image data record of a three-dimensional scatter distribution of the object is reconstructed via a known geometry and a known temporal propagation of wave fronts of the X-ray pulses from spatially and temporally resolved measurement data of the X-ray detector.

According to a further embodiment, the X-ray pulses may have a pulse duration of ≦30 ps. According to a further embodiment, use can be made of an X-ray tube with an RF linear accelerator for accelerating electrons from the X-ray tube in order to generate the X-ray pulses. According to a further embodiment, use can be made of a plurality of successive X-ray pulses, spaced apart in time, and the measurement data therefrom is averaged in each case in order to obtain an image data record with a reduced signal-to-noise ratio. According to a further embodiment, use can be made of a plurality of successive X-ray pulses, spaced apart in time, in order to obtain a plurality of image data records for visualizing temporal changes within the object.

According to another embodiment, a device for X-ray imaging comprises an X-ray source designed for emitting X-ray pulses in an X-raying direction, an examination region formed in the X-raying direction of the X-ray source for holding an object to be X-rayed, and a directionally selective, spatially and temporally resolving X-ray detector with a two-dimensional arrangement of detector elements, which X-ray detector is arranged and formed laterally on the examination region such that it can detect X-ray radiation, scatted at volume elements of the object, in a direction deviating from the X-raying direction in a temporally and spatially resolved fashion.

According to a further embodiment of the device, the X-ray detector can be connected to an evaluation apparatus, which reconstructs an image data record of a three-dimensional scatter distribution of the object via known geometry and known temporal propagation of wave fronts of the X-ray pulses from spatially and temporally resolved measurement data of the X-ray detector. According to a further embodiment of the device, the X-ray source may comprise an RF linear accelerator for accelerating electrons in order to generate the X-ray pulses. According to a further embodiment of the device, the X-ray detector can be provided with a collimator for achieving the directional selectivity.

### BRIEF DESCRIPTION OF THE DRAWINGS

In the following text, the proposed method and the associated device are briefly explained once again on the basis of an exemplary embodiment in conjunction with the drawings, in which:

FIG. 1 shows a schematic illustration of the basic design of the device and the functionality of the method; and

FIG. 2 shows a visual illustration for visualizing the shells with the same propagation time indicated in FIG. 1.

### DETAILED DESCRIPTION

In the proposed method, the object is X-rayed by an X-ray beam bundle emanating from an X-ray source. Here, X-raying is brought about by one or more successive X-ray pulses, spaced apart in time, with a single X-ray pulse already sufficing for carrying out the method. X-ray radiation, scattered at volume elements of the object, is recorded in a direction deviating from the X-raying direction by an X-ray detector with a two-dimensional arrangement of detector elements with not only a spatial but also a temporal resolution. An image data record of the three-dimensional scatter distribution of the object is then reconstructed via the known geometry of the wave front of the X-ray pulse and the known temporal propagation of said wave front from the spatially and temporally resolved measurement data.

Hence, an X-ray source emitting brief, possibly periodic, X-ray pulses is used in the method. The emitted wave fronts penetrate the object to be imaged. A scattered radiation detector, attached laterally for example, uses this to receive temporally staggered scattered radiation from different object regions. If this X-ray detector, as in this case, resolves spatially in two dimensions, a single wave front, i.e. a single X-ray pulse, is sufficient to be able to reconstruct the complete scatter distribution of the three-dimensional object.

In the process, the image recording requires a directionally selective X-ray detector, which substantially detects X-ray radiation from a single direction. This can be achieved by an X-ray detector with a collimator suitably connected upstream. The two-dimensionally arranged detector elements firstly are used to obtain a two-dimensional image of the X-ray radiation from the object scattered in this direction. The additional temporal information and the known propagation time of the X-ray beams of the X-ray pulse likewise resolve the third dimension (in the direction perpendicular to the detector surface). This makes it possible to reconstruct the image data record of the three-dimensional scatter distribution of the object.

The wave fronts of the X-ray pulses emitted by conventional X-ray sources generally have spherical wave fronts. If the X-ray pulses are preferably produced with pulse durations of ≦30 ps, this corresponds to expanding spherical shells of the X-ray radiation with a thickness of approximately 9 mm. In the case of shorter X-ray pulses, this thickness reduces and thereby also increases the image resolution.

In principle, a single X-ray pulse suffices for recording an image data record. It already supplies the complete three-dimensional scatter distribution of the object. In order to improve the signal-to-noise ratio or—in the case of an unchanging signal-to-noise ratio—in order to reduce the X-ray pulse energy, a plurality of X-ray pulses, spaced apart in time, may also be utilized. In this case, the temporally and spatially equivalent measurement data of the individual X-ray pulses are then averaged in order to obtain the image data record.

In another embodiment, an image data record can be generated from the measurement data of each individual X-ray pulse, e.g. in order to be able to register temporal changes in the object.

In known X-ray tubes, an electron beam is directed at an X-ray target in order to generate the X-ray radiation. In order to generate pulsed X-ray radiation, the electrons can be accelerated in the direction of the target in e.g. a radiofrequency (RF) linear accelerator. As a result, X-ray light is produced once per RF period of the linear accelerator for a very short period of time. Hence, the electron target emits a succession of spherical shell-shaped expanding waves, which meet the above requirements. By way of example, if a 1 GHz accelerator tube is used, the individual electron packets incident on the target respectively have a duration of approximately 10 ps. This then also applies to the emitted X-ray pulses. This duration corresponds to a 3 mm thick X-ray beam spherical shell, which propagates through the object. The repetition rate, 1 GHz in this case, leads to a spatial separation of approximately 30 cm between successive X-ray pulses.

Hence, the device proposed for carrying out the method comprises an X-ray source, designed to emit X-ray pulses, and an X-ray detector with two-dimensionally arranged detector elements, which X-ray detector is arranged such that it detects X-ray radiation, scattered from volume elements of the object, in a direction deviating from the X-raying direction in a temporally resolved fashion. The X-ray source preferably has an RF accelerator for the electron beams in order to generate the X-ray pulses. A collimator is preferably provided on the X-ray detector in order to allow directional selectivity, i.e. recording X-ray scattered radiation from one direction. This direction may be perpendicular to the X-raying direction, and so the detector surface is then arranged parallel to the X-raying direction. However, it goes without saying that other alignments of the X-ray detector relative to this X-raying direction are also possible. Here, the X-raying direction corresponds to the direction, from the X-ray source to the object, lying on the axis of symmetry of the X-ray beam bundle. The X-ray detector preferably has sufficient detector rows and detector columns for completely recording the scattered radiation of the object emitted in one direction. However, in principle there can also be a movement perpendicular to this direction by a detector comprising fewer rows or columns in order to record all the scattered radiation of the object. However, this then requires a number of successive X-ray pulses.

The X-ray detector is connected to an evaluation apparatus, in which the three-dimensional scatter distribution of the object is reconstructed in the observation direction from the time profile of the measurement data and the known geometry of the respective X-ray pulse and the propagation thereof through the object. The three-dimensional image data record obtained thereby can then be illustrated in a manner known per se in a rendered visualization or in various slice image views on an image display instrument.

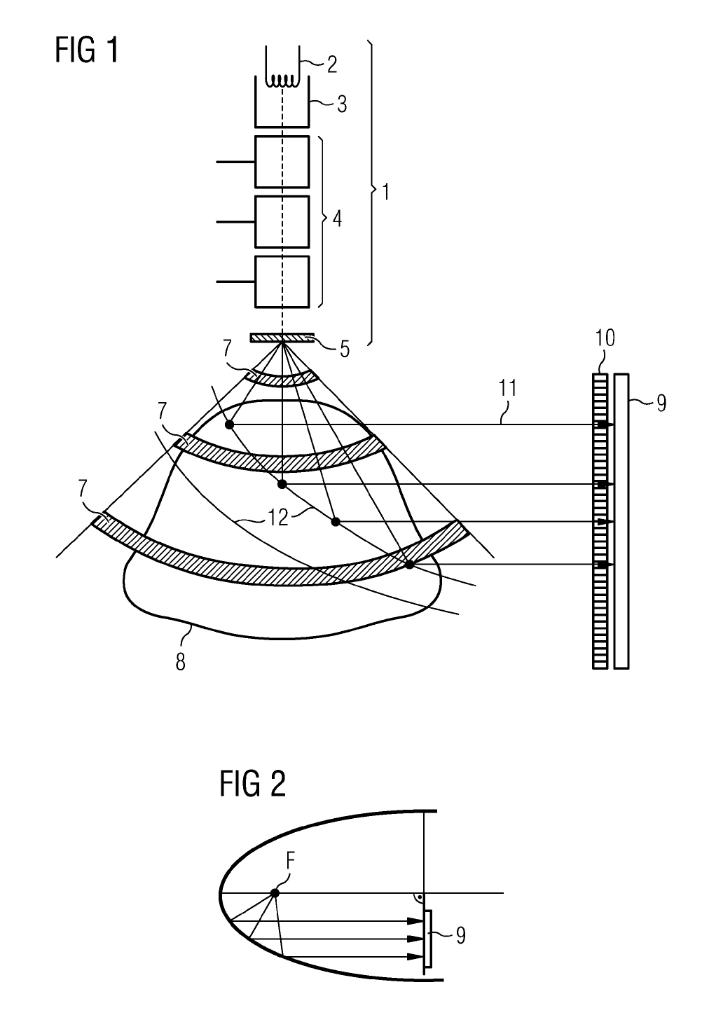

FIG. 1 shows, in a schematic fashion, an example of a device for carrying out the method. To this end, the X-ray source 1 has an electron source 2, a Wehnelt cylinder 3, an RF accelerator 4 and the X-ray target 5. The electrons emitted by the electron source 2 are accelerated packet-by-packet by the radiofrequency of the RF accelerator 4, and so electron beam packets 6 are incident on the X-ray target 5 and generate the X-ray pulses there. As a result of their short duration of e.g. 10 ps, these pulses propagate in the form of the X-ray beam spherical shells 7 indicated in the figure, which X-ray beam spherical shells penetrate the object 8 to be examined. In this example, the X-ray beam spherical shells 7 have a thickness of approximately 3 mm and a mutual spacing of approximately 30 cm.

An X-ray detector 9 is arranged laterally to the object 8 and said X-ray detector has a two-dimensional arrangement of detector elements (not illustrated in this figure). Arranged in front of the X-ray detector in a manner known per se, there is a collimator 10, which only lets X-ray radiation pass that propagates perpendicularly to the detector surface in the direction of the X-ray detector 9. In this example, this direction also corresponds to the direction perpendicular to the X-raying direction or main propagation direction of the X-ray pulses.

The X-ray radiation is scattered at individual volume elements of the object 8 when penetrating the object 8. This scattered radiation 11 (also referred to as secondary quanta) is registered by the X-ray detector 9 in the direction perpendicular to the main propagation direction, as indicated in the figure. As a result of the expansion of the X-ray beam bundle, or the spherical wave fronts, and the different spacing of the volume elements of the object 8 from the detector elements, the scattered radiation emanating from the different volume elements reaches the detector elements at different times. To this end, four different paths for the X-ray radiation are indicated in a merely exemplary fashion in FIG. 1 between X-ray target 5, volume element of the object and X-ray detector 9, which paths all traverse the same distance and are therefore theoretically incident on the X-ray detector 9 at the same time. This results in the shells 12 of the same propagation time, likewise indicated in FIG. 1. The illustrated situation of simultaneous incidence merely serves for visualization here because this situation with the illustrated volume elements does not occur here as a result of the short duration of the X-ray pulses. However, it can be seen that, if the propagation of the wave front of an X-ray pulse is known, it is possible to calculate for each volume element of the object 8 when the X-ray radiation of the X-ray pulse scattered there impinges on the X-ray detector 9. The time of incidence of the X-ray signal affords the possibility of determining for each detector element, which only sees the volume elements of the object 8 situated in the respective observation direction, from which volume element the measurement signal originates. This allows the three-dimensional reconstruction of the scattered radiation distribution of the object.

In this respect, FIG. 2 finally also shows that the shells with the same propagation time lie on rotational paraboloids in which the target focus is situated in the focus. The X-ray detector 9 and individual exemplary beam paths are illustrated in this figure.

### List of Reference Signs

1 X-ray source
2 Electron source
3 Wehnelt cylinder
4 RF accelerator
5 X-ray target
6 Electron beam packets
7 X-ray beam spherical shell
8 Object
9 X-ray detector
10 Collimator
11 Secondary radiation
12 Shells with same propagation time

What is claimed is:

1. A method for X-ray imaging, in which an object is X-rayed by an X-ray beam bundle emanating from an X-ray source, the method comprising:
using one or more successive X-ray pulses, spaced apart in time, for the X-raying,
recording X-ray radiation, scattered at volume elements of the object, in a direction deviating from an X-raying direction by an X-ray detector with a two-dimensional arrangement of detector elements with a temporal and spatial resolution, and
reconstructing an image data record of a three-dimensional scatter distribution of the object via a known geometry and a known temporal propagation of wave fronts of the X-ray pulses from spatially and temporally resolved measurement data of the X-ray detector.

2. The method according to claim 1, wherein the X-ray pulses have a pulse duration of ≦30 ps.

3. The method according to claim 1, wherein use is made of an X-ray tube with an RF linear accelerator for accelerating electrons from the X-ray tube in order to generate the X-ray pulses.

4. The method according to claim 1, wherein use is made of a plurality of successive X-ray pulses, spaced apart in time, and the measurement data therefrom is averaged in each case in order to obtain an image data record with a reduced signal-to-noise ratio.

5. The method according to claim 1, wherein use is made of a plurality of successive X-ray pulses, spaced apart in time, in order to obtain a plurality of image data records for visualizing temporal changes within the object.

6. A device for X-ray imaging with
an X-ray source designed for emitting X-ray pulses in an X-raying direction,
an examination region formed in the X-raying direction of the X-ray source for holding an object to be X-rayed, and
a directionally selective, spatially and temporally resolving X-ray detector with a two-dimensional arrangement of detector elements, which X-ray detector is arranged and formed laterally on the examination region such that it can detect X-ray radiation, scatted at volume elements of the object, in a direction deviating from the X-raying direction in a temporally and spatially resolved fashion.

7. The device according to claim 6, wherein the X-ray detector is connected to an evaluation apparatus, which reconstructs an image data record of a three-dimensional scatter distribution of the object via known geometry and known temporal propagation of wave fronts of the X-ray pulses from spatially and temporally resolved measurement data of the X-ray detector.

8. The device according to claim 6, wherein the X-ray source comprises an RF linear accelerator for accelerating electrons in order to generate the X-ray pulses.

9. The device according to claim 6, wherein the X-ray detector is provided with a collimator for achieving the directional selectivity.

10. The device according to claim 6, wherein the X-ray source has an electron source, a Wehnelt cylinder, an RF accelerator and an X-ray target.

11. The device according to claim 10, wherein electrons emitted by the electron source are accelerated packet-by-packet by the radiofrequency of the RF accelerator, wherein electron beam packets are incident on the X-ray target and generate the X-ray pulses there.

12. The device according to claim 11, wherein the pulses propagate in the form of the X-ray beam spherical shells, which X-ray beam spherical shells penetrate an object to be examined.

13. The device according to claim 12, wherein the X-ray beam spherical shells have a thickness of approximately 3 mm and a mutual spacing of approximately 30 cm.

14. A system for X-ray imaging, in which an object is X-rayed by an X-ray beam bundle emanating from an X-ray source, comprising:
means for providing one or more successive X-ray pulses, spaced apart in time,
means for recording X-ray radiation, scattered at volume elements of the object, in a direction deviating from an X-raying direction by an X-ray detector with a two-dimensional arrangement of detector elements with a temporal and spatial resolution, and
means for reconstructing an image data record of a three-dimensional scatter distribution of the object via a known geometry and a known temporal propagation of wave fronts of the X-ray pulses from spatially and temporally resolved measurement data of the X-ray detector.

15. The system according to claim 14, wherein the X-ray pulses have a pulse duration of ≦30 ps.

16. The system according to claim 14, comprising an X-ray tube with an RF linear accelerator for accelerating electrons from the X-ray tube in order to generate the X-ray pulses.

17. The system according to claim 14, wherein a plurality of successive X-ray pulses, spaced apart in time, is provided and the measurement data therefrom is averaged in each case in order to obtain an image data record with a reduced signal-to-noise ratio.

18. The system according to claim 14, wherein a plurality of successive X-ray pulses, spaced apart in time, is provided in order to obtain a plurality of image data records for visualizing temporal changes within the object.
